(19) United States
(12) Patent Application Publication
(10) Pub. No.: US 2011/0301894 A1
(43) Pub. Date: Dec. 8, 2011

(54) Method and System for Non-Intrusive Load Monitoring and Processing

(75) Inventor: H. Britton Sanderford, JR., New Orleans, LA (US)

(73) Assignee: SENSUS USA INC., Raleigh, NC (US)

(21) Appl. No.: 13/152,468

(22) Filed: Jun. 3, 2011

Related U.S. Application Data
(60) Provisional application No. 61/351,484, filed on Jun. 4, 2010.

(51) Int. Cl. G06F 19/00

(52) U.S. Cl. 702/65

(57) ABSTRACT

A system and method for use in a non-intrusive load monitoring system to identify specific types of loads and communicate the identified load information to interested parties. The non-intrusive load monitoring system includes an electricity meter that measures load information from a home or facility. The load information is analyzed by comparing the information to a series of load signatures for various known electrical loads to identify the specific type of electric load. Once the type of load is identified, the system utilizes the information to analyze the operation of the load and relay messages to the home owner regarding such operation. The load information may be used by a utility to better predict and manage peak and average electricity consumption over the year. Upon customer authorization, the load identification information may also be relayed to third parties for use in directed sales campaigns and discount promotions.

### CROSS-REFERENCE TO RELATED APPLICATION

The present application is based on and claims priority to U.S. Provisional Patent Application Ser. No. 61/351,484 filed Jun. 4, 2010.

### BACKGROUND

The present disclosure generally relates to a method and system for monitoring load characteristics of electric loads in a residential or commercial setting through the use of an electricity meter and identifying the specific types of loads and their respective operating conditions. More specifically, the present disclosure relates to a method and system that monitors the load characteristics of electrical loads and communicates the identification information related to each of the loads to a system operator or a third party for review, analysis and possible direct communication to the owner/operator of the electrical load.

Electric utilities in commercial facilities are interested in monitoring detailed electric power consumption profiles of their customers to analyze the amount of energy being utilized and for monitoring peak load levels and the time of such peaks. Typically, this energy consumption is monitored for the complete residence or commercial facility, since monitoring the energy consumption of each individual appliance contained within the residence or facility typically requires placing a monitoring device on each of the electric loads within the facility. However, acquiring knowledge of the energy consumption of each individual load within the facility would provide additional information for both the owner and the utility in monitoring energy consumption.

In an attempt to monitor energy consumption by each individual electric load within the facility, systems and methods have been developed to track the energy consumption of electric loads within the facility without requiring separate monitoring of each of the loads. One technique to carry out this type of monitoring is referred to as non-intrusive load monitoring. Non-intrusive load monitors (NILM) are devices intended to determine the operating schedule of major electrical loads in a building from measurements made outside of the building. Non-intrusive load monitoring has been known since the 1980's (see Hart U.S. Pat. No. 4,858,141). Non-intrusive load monitoring is generally a process for analyzing the changes in the voltage and currents going into a house and, from these changes, deducing what appliances are used in the house as well as their individual energy consumption. The NILM compares the energy consumption information from the home, such as recorded at an electric meter, and compares the energy consumption information to known load profiles for different types of electrical loads.

Although non-intrusive load monitoring has been known for many years, utilities and other interested parties have been unable to leverage the information obtained from a non-intrusive load monitor.

### SUMMARY

The present disclosure relates to a system and method for the non-intrusive monitoring and identification of one or more electrical loads located within a facility. The system generally includes an electricity meter positioned to monitor the load characteristics, such as voltage, current and phase, of a series of loads in a residential or commercial setting. The electricity meter includes both a current monitor and a voltage monitor that receive the load characteristics for the facility and convert the load characteristics to a digital voltage signal and a digital current signal.

In one embodiment of the disclosure, a correlator is contained within the electricity meter and is configured to receive the digital voltage signal and the digital current signal and compare select attributes of the signals to a plurality of representative load signatures also stored within the electricity meter. Based up on the comparison between the digital voltage signal and the digital current signal and the stored, representative load signatures, the correlator within the electricity meter identifies a particular model (e.g., manufacturer model) and/or type (e.g., type of appliance) of various electrical loads operating within the monitored facility.

The load identification information, as well as time of day usage information, is relayed from the electricity meter to a remote location, such as a back end server provided by the utility or a separate data aggregator. The load identification information could be stored for a period of time in the electricity meter before being relayed to the remote location or could be relayed in near real-time. In an alternate embodiment, the remote utility back end or data aggregator includes the load profile storage device, such as non-volatile memory, as well as the correlator such that the load identification step is performed outside of the electricity meter. In each case, the correlator and load profile storage device combine to identify the specific type and/or of electric load operating at the monitored facility.

Once the specific type and/or model of electric load has been identified by a comparison between the operating load profile(s) for the facility and the stored load signatures, the system and method of the present disclosure can send email or other types of messages to the home/business owner regarding the specific operation of the electric loads within the facility. As an example, messages may be sent to the home/business owner suggesting a change in the time of operation of the electric loads to reduce the home/business owner's electric utility bill by operating the loads during off-peak periods. Additionally, information can be sent to the home/business owner suggesting replacement of electric loads or suggesting service that needs to be performed on the electric loads to have the electric loads operating in a more efficient manner.

In yet another contemplated embodiment, the electric load identification information can be relayed to a third party for a subscription fee paid to the utility. The third party may be a product manufacturer, a product distributor, a product retailer or a third party data provider. A third party data provider, in turn, could contract with the product manufacturer, product distributor or product retailer to provide service leads at a fee.

Various other features, objects and advantages of the invention will be made apparent from the following description taken together with the drawings.

### BRIEF DESCRIPTION OF THE DRAWINGS

The drawings illustrate the one mode presently contemplated of carrying out the disclosure. In the drawings:

FIG. 1 is a schematic illustration of a non-intrusive load monitoring system of the present disclosure;

FIG. 2 is an alternate embodiment of the non-intrusive load monitoring system of the present disclosure;

FIG. 3 is an illustration of the various different types of load profiles that can be stored in the system of the present disclosure;

FIG. 4 is a representative load on an electricity meter;

FIG. 5 depicts current and voltage profiles that occur after a triggering event; and

FIG. 6 is a flowchart illustrating one possible operating procedure utilized while operating within the scope of the present disclosure.

### DETAILED DESCRIPTION OF THE INVENTION

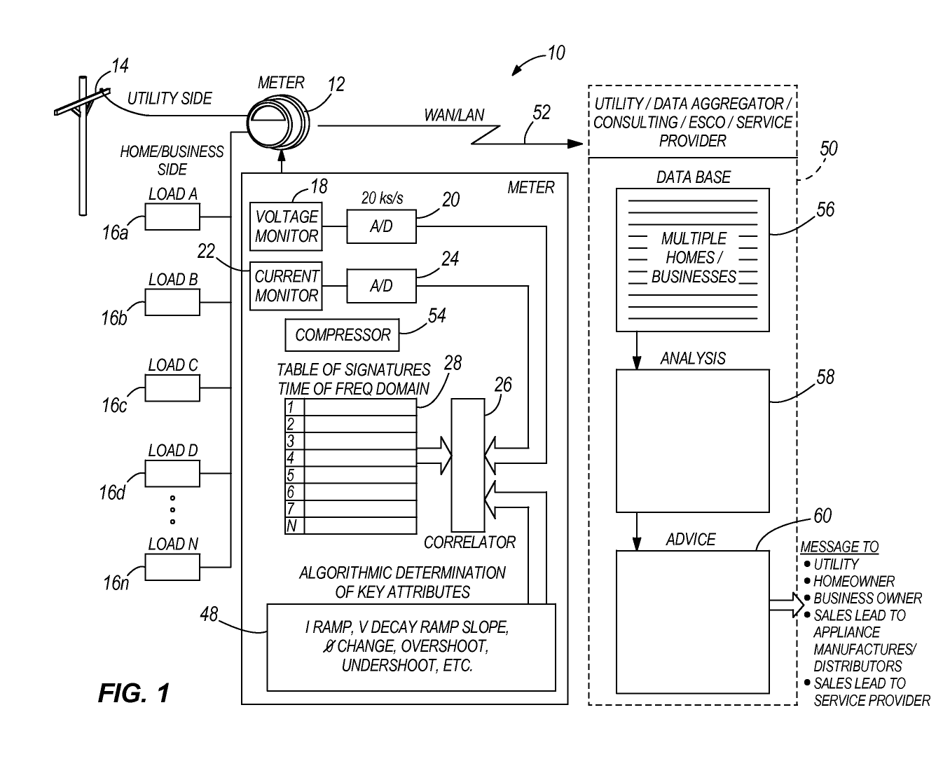

FIG. 1 is a block diagram of a non-intrusive load monitoring (NILM) system 10. The NILM system 10 illustrated in FIG. 1 includes an electricity meter 12 connected to a supply of electricity from a utility service provider 14. Electric power from the utility service provider 14 travels through the meter 12 and is distributed to a series of individual loads 16a-16n. The individual loads 16 receive electricity through the meter 12 such that the meter 12 monitors and determines the amount of electricity consumed by the aggregate combination of the loads 16a-16n. Each of the individual loads 16a-16n is typically contained within a single facility, such as a home residence or commercial facility. The electricity meter 12 accumulates the amount of energy consumed by the facility and reports the total energy consumption to a utility for billing and monitoring purposes.

Non-intrusive load monitoring can be used to determine the operating schedule of individual electric loads contained within a facility by monitoring and analyzing the energy consumption for the entire facility. In the embodiment shown in FIG. 1, non-intrusive load monitoring can be performed on the aggregated energy consumption for the loads 16a-16n to identify the particular types and models of the loads 16a-16n contained within the facility. Non-intrusive load monitoring is a known technique, as set forth in “Non-Intrusive Appliance Load Monitoring System Based On A Modern kWH-Meter”, Technical Research Center of Finland, ESPOO 1998, as well as U.S. Pat. No. 4,858,141. The NILM monitoring techniques described in the two references set forth above disclose the concept of comparing a load profile from a facility to known load signatures for different types of electric loads and, based upon the comparison, identifying the type of load contained within a facility. The disclosure of the references set forth above is incorporated herein by reference.

In the embodiment shown in FIG. 1, the electricity meter 12 includes a series of internal components that allow the electricity meter 12 to function as part of a non-intrusive load monitoring system. The electricity meter 12 includes a voltage monitor 18 that monitors the voltage consumption of the series of electrical loads 16. The voltage monitor 18 includes an analog to digital converter 20 that samples the analog voltage signal at, for example, a sample rate of 20 ks/s.

In addition to the voltage monitor 18, the meter 12 includes a current monitor 22 that also feeds an analog to digital converter 24. The analog to digital converter 24 samples the analog current signal at, for example, 20 ks/s. Although sampling rates for both the A/D converters 20, 24 are described, it should be understood that the A/D converters could sample the signals at different sampling rates.

In the embodiment shown in FIG. 1, the sampled voltage and current signals from the A/D converters 20, 24 are each fed to a correlator 26. The correlator 26 is a component of, or operates with, the electricity meter 12 and is programmed and functions to compare the sampled voltage and current signals to a table of stored load signatures for both a plurality of different types of electric loads as well as a plurality of different electric load models within each of the electric load types. The table of load signatures is generally indicated by reference numeral 28 in FIG. 1. The table of signatures 28 can include as many load signatures as desired, depending upon the memory capabilities of the electricity meter 12.

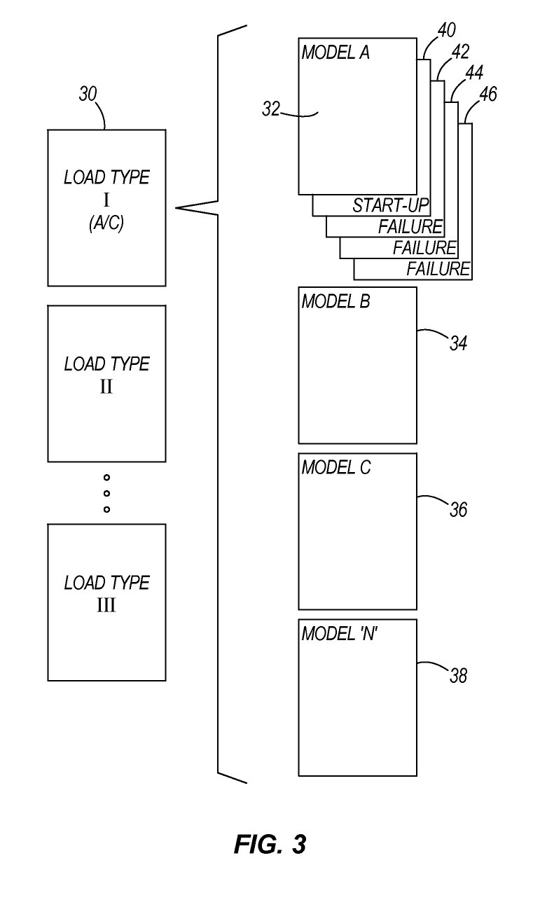

FIG. 3 illustrates one possible structure for the table of signatures 28. In the illustration of FIG. 3, a first load type 30 is illustrated, load type 1. In this embodiment, load type I represents the general category of air conditioners. However, it should be understood that load type I could be other types of electrical loads, such as hot water heaters, pool pumps, baseboard heaters, electric cars, hair dryers, computers, televisions or any other type of relatively significant electricity-consuming loads that could be utilized within the facility being monitored.

Load type I, shown by reference numeral 30, is a first level of a memory tree structure. The memory tree structure includes a series of specific model types 32-38 that fall within the general category of load type I. As an example, Model A could be a specific model provided by a first air conditioner manufacturer. Model B, illustrated by reference numeral 34, could be a different model number also from the first manufacturer. Model C, referred to by reference numeral 36, could be a model from a second air conditioner manufacturer.

The primary profile 32 for Model A is shown as one of the load signatures stored in the memory of the electricity meter. In addition to the general operating signature, the database could also store a startup signature 40, a first fault/failure signature 42, a second fault/failure signature 44 and possibly a third fault/failure signature 46 (or more). Each of these load signatures is provided by the manufacturer of the electricity-consuming appliance or a third-party profile generator. The fault/failure signatures 42-46 can represent various different common failure modes for the electrical load, such as the failure of a compressor in an air conditioner, the failure of a starting capacitor, or any other fault mode for the electrical load and can be detected through a monitored load profile. It should be understood that under each of the model types, various different startup signatures, fault signatures and failure signatures can be provided depending upon the specific manufacturer for the appliance. The use of both the startup signature and the various fault/failure signatures allows the non-intrusive load monitoring system of the present disclosure to not only identify the particular type and model of the electrical load, but also to diagnose operating problems that may occur or are present during operation of the electrical load. The significance of this monitoring feature will be described in detail below.

Referring back to FIG. 1, the correlator 26 receives the voltage and current signals from the analog to digital converters 20, 24 as well as uploading algorithm information from an algorithm database 48. The algorithm database 48 includes an identification of which key attributes of both the voltage and current signals that the correlator 26 should utilize to compare the voltage and current information from the meter 12 to the stored signature profiles from the table of signatures 28. As an illustrative example, the correlator 26 will compare between ten to twelve key attributes from each of the input signals to the same attributes in the load profiles from the table of signature profiles 28. These attributes may include the current ramp upon initial activation of the load, the voltage decay ramp slope, the phase change, overshoot, undershoot, as well as other key attributes that can be identified and utilized to compare the voltage and current profiles from the electricity meter to the stored signature profiles. The various key attributes are detected in the load profile of the facility being monitored. Although several possible key attributes are set forth above, it should be understood that other types of attributes could be detected depending upon the type of load and the fault/failure profiles for each. The algorithm database may indicate both the type and number of key attributes use for the comparison and may vary based on the signature profile to which the voltage and current information are compared.

The signature profiles stored in the table of signature profiles 28 are provided by manufacturers and identify key attributes in the activation and/or operation of the electric load that are utilized to compare a load profile from the facility to stored information. Although in the illustrative example the correlator compares between ten to twelve key attributes, it should be understood that different numbers of attributes could be utilized while operating within the scope of the present disclosure. In general, the larger the number of attributes compared between the measured load profile from the facility and the signature profiles stored in the table of signature profiles 28 will increase the accuracy of the comparison process. However, the larger number of key attributes that are compared will also increase the processing requirements for the electricity meter and the volume of information that must be stored for each of the load profiles from the facility. It is contemplated that a comparison of between ten to twelve key attributes will typically be adequate to perform the comparison process of the present disclosure. In some cases, less than ten to twelve key attributes will be sufficient, depending upon the load.

Based upon the comparison of the load profile from the meter 12 to the series of load signatures stored in the table of signature profiles 28, the correlator 26 can identify what type of load is being activated and/or operating at the facility. Alternatively, the correlator 26 can instead initially determine the specific model of the electric load at the facility without having to first identify the type of load. In some embodiments, the correlator 26 can determine both the type and model of the load.

In some embodiments, the correlator 26 calculates a confidence indicator that is based upon the degree of matching between the analyzed profile and the signature profiles contained within the table of signature profiles 28 (e.g., the number of attributes used or matched, how well the attributes from the analyzed profile align with those of the signature profiles, etc.). The confidence value can range, for example, between 0-100 depending upon the level of matching detected. It is contemplated that a particular load profile from the facility may correspond to a signature profile for different models of a certain type of load. As an example, a measured load profile may correspond to different models of an air conditioner from the same manufacturer or different models of air conditioners from different manufacturers. After each measurement cycle, the correlator selects the identified type of load and specific model that has the highest confidence value as the most likely type of electric load being operated within the monitored facility. The correlator 26 provides a confidence value during each measurement cycle and, over time, can more accurately determine and estimate the type of load at the facility based upon a history of analysis.

As illustrated in FIG. 1, the meter 12 relays information to a utility/data aggregator 50 over a wired or wireless connection 52. In the embodiment shown in FIG. 1, the utility 50 can be a utility service provider or, alternatively, can be other types of data aggregators, consulting companies or different types of service providers that are designated to receive information from the electricity meter 12. Throughout the rest of the disclosure, the term “utility” will be utilized; however, it should be understood that the utility 50 could be an independent service provider, data aggregator (e.g., an advertiser or advertising service), or any other facility that receives information from the electricity meter 12.

The electricity meter 12 includes a data compressor 54 that compresses data prior to transmitting the data over the wireless connection 52. It is contemplated that the data compressor could be utilized to compress information before the information is transmitted in various different manners. In one contemplated embodiment, the utility meter 12 compresses all of the measured voltage and current information, as well as the analysis generated by the correlator 26. In such an embodiment, the compressor 54 is required due to the large amount of data as a result of the high sampling rate of both the A/D converters 20, 24.

In an alternate embodiment, the data compressor 54 compresses only the selected attributes of the current and voltage information from the facility as determined by the correlator 26 in combination with the algorithm database 48. In this embodiment, the amount of information transmitted from the meter to the utility 50 is reduced relative to the transmission of the entire load profile such that different types of compression techniques can be utilized.

In each type of data compression technique, the information from the meter 12 also includes time stamps such that the consumption information is relayed to the utility 50 with the specific time of day in which the energy consumption occurred. The time of use information is useful to the utility in analyzing the energy consumption and providing information and suggestions to the home/business owner.

Once the utility 50 receives the information from the electricity meter 12, the utility stores the received information in a database 56 for each of the homes/businesses being served by the utility. The database 56 is typically a hardware-based database contained at the utility 50.

An analysis module 58 contained as a processor or processors at the utility 50 accesses the information contained on the database 56 for each individual residence/business served by the utility. The analysis module 58 analyzes the current and voltage information received from the meter 12, the time of use information and the identified electrical load types and/or models as identified by the correlator 26. As discussed, the voltage and current information sent from the meter 12 includes time stamping such that the analysis module 58 can determine the amount of energy consumed by each of the identified loads and the time of day of such consumption. As an illustrative example, the analysis module 58 may determine that the homeowner operated an electric washing machine, having a specific model number and manufacturer, from 2 p.m. to 4 p.m. on Wednesday afternoon. Based upon this time of operation and the increase in the energy consumption for the facility at that time, the analysis module 58 can determine the cost of electricity for operating the identified load at the specific time.

The processors at the utility 50 further include an advice module 60 that processes the analysis results created by the analysis module 58 to generate different advice recommendations to the home/business owner based upon the amount of time each of the identified electrical loads was operated and suggest improvements in the use of their electrical appliances to save energy costs. As an example, the advice module 60 can generate a message to a homeowner that advises the homeowner that if they operate their washing machine at 9 p.m. on Wednesday night instead of 3 p.m., the energy savings will be approximately $8.00 per month. It should be understood that the advice module 60 can include various different algorithms that allow the advice module 60 to generate different messages to the home/business owner. As an illustrative example, the advice module can use historical rate information to generate the cost difference for operation of the load at different times and generate a maximum cost savings in a time window.

As discussed previously with reference to FIG. 3, the table of signature profiles can include fault/failure profiles, such as failure profiles 42-46 for each one of the different models of each load type. In some embodiments, the entire category of load type, such as air conditioners, can have a specific fault/failure profile that can be identified. When the correlator 26 identifies a failure mode in any one of the electrical loads at the home/business, the advice module 60 can relay message to the home/business owner indicating that a particular electrical load is not operating properly. For example, if the correlator 26 identifies that a compressor of an air conditioner is operating improperly, the advice module 60 can send a message to the homeowner that the compressor is in need of service or replacement.

In addition to messages sent to the home/business owner, the advice module 60 can contact different manufacturers, retailers, distributors, or other interested personnel to provide electric load information to this third party provider. As an example, if the analysis module 58 determines that a homeowner has a particular brand and model of air conditioner that is either old or operating improperly (based on the matching to a certain signature profiles), the advice module 60 can send a message to a subscribing manufacturer/distributor/retailer with information regarding the electric load operation or condition. The manufacturer/distributor/retailer can then tailor a particular email or other type of message to the homeowner that their particular air conditioner is operating improperly. It is contemplated that such a message may also include purchasing information for a new model that operates more efficiently.

In such a configuration, the utility 50 can obtain revenue from the manufacturer/distributor/retailer to provide the model and operating parameters of electric load(s) at each individual home or business. By selling this information to a manufacturer/distributor/retailer, the utility 50 can recover costs associated with the system as well as generate additional revenue.

In yet another alternate configuration, the utility 50 can provide load identification information for each individual home/business being monitored to a third party data provider, such as online search engine providers. In such an embodiment, the third party data provider could then, in turn, use such information for targeted advertising. It is contemplated that interested parties may include manufacturers, distributors and/or retailers of electrical appliances. Third party data providers can serve as an intermediate party between the utility 50 and the third party interested in contacting the home owner or business. The third party receiving information from the data provider could then contact the home owner to advertise replacement products where the replacement products are specifically tailored to the current products contained within the home. The information from the data provider would serve as a sales lead to the third party manufacturer/distributor/retailer and would be valued by the data provider as demanded.

In addition to selling information to product manufacturers/distributors/retailers, it is also contemplated that the analysis module 58 and the advice module 60 can be utilized by the utility to suggest updates/changes to the homeowner's electric loads to reduce energy consumption or to otherwise tailor energy consumption profiles as desired by the utility.

As part of the information provided to the homeowner to reduce or optimize energy consumption, it is contemplated that the electricity meter 12 may include a temperature sensor such that the information received by the utility 50 will include the current temperature at the business/home. Alternatively, the utility 50 can obtain temperature information for the area and correlate the obtained temperature data with the time stamp on the energy consumption. Temperature information is particularly desirable to determine whether air cooling devices or heaters are operating efficiently. In addition, the utility 50 can also obtain information about the home through commercially available channels, such as online maps or the equivalent thereof. The home-type information will allow the utility 50 to generate a profile for the home which will allow the utility 50 to better analyze the energy consumption information provided from the electricity meter 12.

Based upon all of the information acquired by the utility 50, the utility 50 can contact the homeowner and provide messages to the homeowner related to the operating efficiency of the home. Such messages may suggest additional insulation for the home to reduce heating or cooling costs, replacement of inefficiently operating electric loads or changes in the operating schedule of energy consuming loads which may result in energy savings, and hence cost savings, for the homeowner.

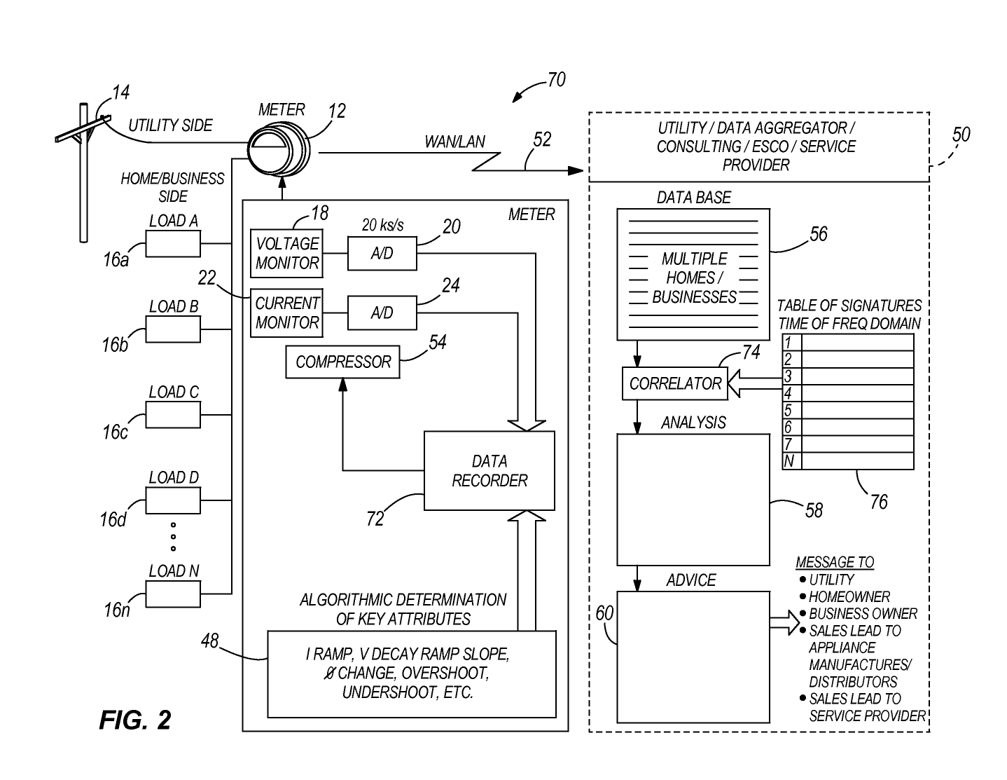

Referring now to FIG. 2, thereshown is an alternate configuration of the non-intrusive load monitoring system, as generally referred to by reference numeral 70. Many of the operating components in the system 70 shown in FIG. 2 are similar to those in FIG. 1 and similar reference numerals are utilized when appropriate.

In the embodiment shown in FIG. 2, the electricity meter 12 is configured to include four operating components as compared to the embodiment shown in FIG. 1. The electricity meter 12 still includes a voltage monitor 18, a current monitor 22 and associated A/D converters 20, 24. However, in the embodiment shown in FIG. 2, the electricity meter no longer includes the correlator or a stored table of load profiles. Instead, the system shown in FIG. 2 includes a data recorder 72 that communicates with the algorithm database 48. The data recorder 72 records the key attributes of the voltage and current signals, as indicated by the algorithms contained in the database 48. The data recorder 72 communicates with the compressor 54 to compress the identified key attributes and transmit the compressed key attributes over the connection 52. Alternatively, the data recorder 72 may record and transmit the entire voltage and current profiles from the electricity meter 12 over the connection 52.

In the embodiment of FIG. 2, the utility 50 also includes many similar operating components as the embodiment shown in FIG. 1. The information received from the meter 12 is stored within the database 56. However, in the embodiment of FIG. 2, a correlator 74 and a table of signature profiles 76 are included at the utility 50 rather than on each individual meter. The correlator 74 and the table 76 operate in the same manner as described with reference to FIG. 1. However, these components are included at the utility 50 rather than on each individual meter.

The results of the correlator 74 are fed to a similar analysis module 58 and advice module 60 in the same manner as previously described.

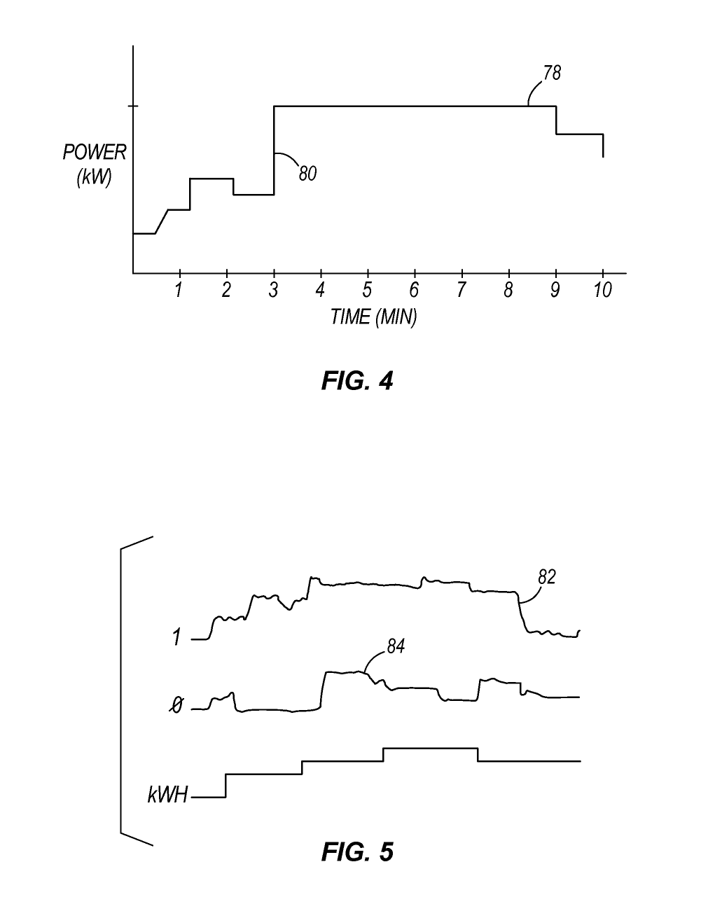

Referring now to FIG. 4, thereshown is a sample load profile from the electricity meter 12. The load profile 78 illustrates the power consumption (kW) as a function of time. Transition point 80 indicates that an electric load has been activated, which results in the increase in power consumption at point 80. When the electricity meter 12 identifies the transition shown at point 80, the voltage and current monitors 18, 22 begin to sample the voltage and current information at the data sampling rate of 20 ks/s. In addition to sampling the data after the transition point 80, it is contemplated that the internal memory within the meter can also retrieve voltage and current information from a time immediately prior to the transition point 80. In some cases the load profile for an individual electrical device has most of its distinguishing and identifying characteristics near startup. Thus, it is important to record current and voltage information near the startup of an electrical device to conduct the load profile comparison process described above.

FIG. 5 illustrates a current profile 82 and a voltage profile 84 following the transition in the load profile 78. As previously described, based upon the voltage and current profiles, the correlator attempts to identify the type and model of the electric load. In some cases, the load profile for the electric load can be most easily identified utilizing load profile identification techniques based on voltage and current signal characteristics at the point immediately prior to and immediately following the activation of an electric load. Thus, in some embodiments, the system of the present disclosure relies on key attributes of the electric load operation typically around starting, and possibly around shutdown of the electric load.

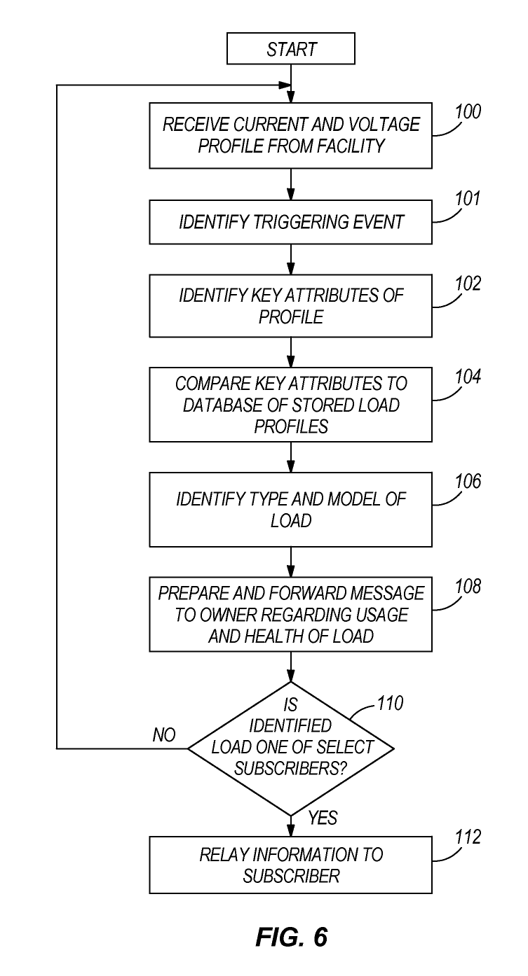

FIG. 6 illustrates one operational example for the non-intrusive load monitoring system of the present disclosure. Although one example is shown in FIG. 6, it should be understood that various other steps and embodiments are contemplated as being within the scope of the present disclosure.

As illustrated in step 100, the system initially receives the current and voltage profile from the facility. In the embodiment shown in FIG. 1, the current and voltage profile is for each of the loads 16a-16n that exists at the facility.

Once the current and voltage profiles are received from the facility being monitored, the operating components within the electricity meter 12 identify a triggering event, as illustrated in step 101. As described with reference to FIG. 3, a triggering event may be a sudden increase in the power consumption at the facility, which signifies the activation of an additional electrical load. Triggering events may also include decreases and other changes in the power consumption at the facility. Since most of the key attributes used to identify the type of load being activated occur near the initial startup of the electrical load, the step 101 of identifying the triggering event includes recording information from the current and voltage signals slightly before and after the triggering event occurs. In one embodiment, the triggering event is a change in the power consumption of a facility above a threshold value. It is contemplated that the threshold value may be a percentage increase in the power consumption, which indicates the activation of a relatively large power consuming load. When the change in power consumption exceeds the threshold value, the system begins the analysis process.

In both of the embodiments shown in FIGS. 1 and 2, once the triggering event has been detected, the current and voltage profiles are compared to an algorithm database 48 to identify key attributes of each of the current and voltage profiles, as indicated in step 102. As previously described, the key attributes of both the voltage and current signals may include ten to twelve values, including, but not limited to, the current ramp slope, the voltage decay ramp slope, the phase change, overshoot, undershoot, as well as other different attributes that can be utilized to identify a load profile.

In step 104, the identified key attributes are compared to a database of stored load signatures. In the embodiment shown in FIG. 1, the database of stored load signature profiles are contained within the table 28 in the electricity meter. In the embodiment of FIG. 2, a similar table exists at the utility 50. In each case, the key attributes of the voltage and current profiles are compared to stored signature profiles in step 104.

In step 106, the correlator 26 of FIG. 1 or the correlator 74 of FIG. 2 identifies the type and/or model of the electric load based upon a comparison to the table of signatures. The correlator assigns a confidence value to the identification to indicate the probability of the load corresponding to the identified profile.

Once the load type has been identified in step 106, the load type is relayed to an analysis and advice module such as analysis module 58 and advice module 60. The analysis and advice modules prepare and forward messages to the owner regarding the usage and health of the electric load identified, as indicated in step 108. As previously described, the message sent by the utility can provide various different types of information to the home/business owner, such as a suggestion to the owner to modify operation of the electric load, a health report of the load, or any other type of information that the utility wishes to direct to the home/business owner.

In step 110, the system can additionally relay the identified load type and consumption profile information to a third party subscriber, such as a product retailer, product distributor or manufacturer. It is contemplated that the product manufacturer, product distributor or retailer can contract with the utility to receive messages from the utility regarding use of various different electric loads.

In step 110, the system determines whether the identified load is one type of load in which the system will send a report to a third party subscriber, such as the manufacturer, distributor, retailer or data provider identified above. If it is not one of the selected types, the system returns to step 100 and continues to monitor the current and voltage profile from each electricity meter.

It is contemplated that the system will allow a user the ability to opt in/out of the data analysis procedure and the relay of usage information to third party subscribers. If the user does not want their information relayed to the third party subscriber, the user can inform the utility and be removed from the program.

However, if in step 110 the system identifies that the load is one of the types in which a subscriber is interested in receiving information, the system relays this information to the subscriber in step 112. Once this information is received, the subscriber can send information to the homeowner/business owner regarding information and potential sales information for the homeowner. As an example, if the system identifies that a home occupant has a model A refrigerator that is no longer operating efficiently, the system may send the information to a retailer of model A refrigerators. The retailer would then contact the homeowner to tell the homeowner that the current refrigerator in their home is not operating properly and/or is out of date, and may include information about the possibility of purchasing an updated product and the energy savings that may result. As previously described, each subscriber would pay a fee to the utility to receive information from the utility customers.

We claim:

1. An apparatus for the non-intrusive monitoring and identification of one or more electrical loads located at a facility, the apparatus comprising:
a voltage monitor that receives a voltage signal from the facility and converts the voltage signal into a digital voltage signal;
a current monitor that receives a current signal from the facility and converts the current signal into a digital current signal;
a load signature storage device contained within the apparatus that stores a plurality of representative load signatures for a plurality of different electrical loads; and
a correlator configured to receive the digital voltage signal and the digital current signal and compare select attributes of the signals to the plurality of representative load signatures to identify the electrical loads in the facility.

2. The apparatus of claim 1 wherein the plurality of representative load signatures includes signatures for a plurality of types of electrical loads.

3. The apparatus of claim 2 wherein the plurality of representative load signatures includes representative load signatures for electrical loads from more than one manufacturer for each of the types of electrical loads.

4. The apparatus of claim 3 wherein the plurality of representative load signatures includes representative load signatures for individual models for each manufacturer such that the correlator identifies the model, manufacturer and load type of the electrical loads.

5. The apparatus of claim 1 wherein both the current monitor and the voltage monitor record the digital signals before and after a triggering event.

6. The apparatus of claim 5 wherein the triggering event is identified as a change in power consumption of the facility above a threshold value.

7. The apparatus of claim 1 further comprising a data compressor contained within the apparatus and operable to compress the identification information prior to transmission from the apparatus.

8. The apparatus of claim 1 wherein the apparatus is an electrical meter.

9. A system for the non-invasive monitoring and identification of one or more electrical loads in each facility of a plurality of facilities, the system comprising:
an electricity meter associated with each facility, each electricity meter being configured to obtain a digital voltage signal and a digital current signal based on the energy consumption of the facility;
a data analysis system in communication with the electricity meter;
a load signature storage device that stores a plurality of representative load signature; and
a correlator configured to compare select attributes of the digital voltage signal and the digital current signal to the plurality of representative load signatures to identify each electrical load in the plurality of facilities.

10. The system of claim 9 wherein the load signature storage device and the correlator are located within the data analysis system.

11. The system of claim 9 wherein the load signature storage device and the data analysis system are each contained with in the electricity meter.

12. The system of claim 9 wherein the plurality of representative load signatures include representative load signatures for a plurality of types of electrical loads.

13. The system of claim 12 wherein the plurality of representative load signatures includes representative load signatures for electric loads from more than one manufacturer for each of the types of electrical loads.

14. The system of claim 13 wherein the plurality of load signatures include load signatures for individual models for each manufacturer such that the correlator identifies the model, manufacturer and load type for each of the electrical loads.

15. The system of claim 9 wherein the electricity meter is configured to identify the select attributes of the digital voltage signal and the digital current signal, wherein the electricity meter communicates the selected attributes to the data analysis system.

16. The system of claim 15 wherein the electricity meter identifies the select attributes based upon an analysis of the voltage digital signal and the current digital signal before and after a triggering event.

17. A method of analyzing the energy consumption of a facility having a plurality of electrical loads, comprising the steps of:
obtaining an actual load profile for the facility;
comparing the obtained load profile for the facility to a plurality of stored representative load signatures for a plurality of different electrical loads;
identifying the electrical load based on the comparison of the obtained load profile and the representative load signatures; and
conveying the identity of the load to a third party.

18. The method of claim 17 wherein the third party is a product manufacturer.

19. The method of claim 17 further comprising the step of generating a message from the third party based on the identity of the load.

20. The method of claim 19 further comprising the steps of:
obtaining energy usage information for the identified load;
conveying the energy usage information to the third party; and
directing a message from the third party based upon the energy usage information.

21. The method of claim 20 wherein the energy usage information includes time of use and duration of use for each of the identified electrical loads.

22. The method of claim 21 wherein the message includes instructions on how to reduce energy consumption costs.

23. The method of claim 17 further comprising the steps of:
comparing the obtained load profile from the facility to a plurality of fault signatures for the plurality of electrical loads; and
generating a fault message when the load profile corresponds to one of the fault signatures.

24. The method of claim 18 further comprising the step of conveying a product sales message from the third party based on the identity of the load.

25. The method of claim 17 further comprising the steps of:
obtaining the stored representative load signatures from a plurality of product manufacturers;
storing the obtained representative load signatures in a database; and
charging each of the product manufacturers for storing the representative load signatures.

26. The method of claim 17 further comprising the step of identifying improper operation of the electrical loads based on the comparing step.

27. The method of claim 18 further comprising the step of charging the product manufacturer a fee to convey the load identity information.

28. The method of claim 17 wherein the load profile for the facility is determined during a period before and after a triggering event.

29. The method of claim 17 wherein the load profile for the facility is obtained in an electric meter that feeds the facility.

30. The method of claim 29 wherein the step of identifying the electrical load occurs within the electricity meter.

31. The method of claim 17 further comprising the steps of:
comparing the obtained load profile from the facility to a plurality of failure signatures for the plurality of electrical loads; and
generating a failure message when the load profile corresponds to one of the failure signatures.
